(19) United States
(12) Patent Application Publication
(10) Pub. No.: US 2003/0057165 A1
(43) Pub. Date: Mar. 27, 2003

(54) Process for the separation of a liquid or liquids from another liquid or liquids, or from a solid or mixture of solids, with the minimum energy required for separation and recovery and recovered for re-use within the process

(76) Inventor: Thomas Powell Carson, Moody, ME (US)

Correspondence Address: THOMAS P. CARSON, PO Box 175, 183 Royal Heights, Moody, ME, 04054, US

(21) Appl. No.: 09/961,809

(22) Filed: Sep. 25, 2001

(51) Int. Cl. C02F 1/00

(52) U.S. Cl. 210/774

(57) ABSTRACT

A vaporization-condensation process using the refrigerant cycle (heat pump) for energy recycling between the vaporization and condensation processes with the refrigerant heat absorption/rejection capacity maximized to minimize installed power by controlling the system operating pressure (absolute) and allowing for the recovery of the condensable liquid vaporized, directly, indirectly, and within the seal liquid of the liquid ring pump if included in the system to; provide the less costly operating system feasible, recover one liquid from another, remove a liquid or liquids from a solid, purify water and, eliminate or minimize gas admission to the environment.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

This invention relates to the areas of waste reduction, material recovery, and water production-purification through the removal of a liquid or liquids from a mixture of liquids, or the removal of a liquid or liquids mixed with a solid or solids, or for the separation of pure water from an impure source. Many processes produce by-products that contain elements or materials that are re-usable and need separation from unwanted materials. Separating useable material or safe material from the by-product can reduce waste disposal cost by reducing volume and weight. Such a removal process can also increase the economic value of the end product allowing for a reduction in the use of virgin material.

For example, sewage plant waste can be disposed of more economically by reducing weight and resultant transport costs through drying. Similarly, sawdust or other wood waste can be transported less costly and being dried has a higher heat value for use as a fuel. Solvents used for cleaning can be separated from the waste material gained during the cleaning process. Water or other condensable products can be removed from petroleum products such as oil.

The natural supply of safe drinking or other forms of pure water is decreasing resulting in the ever increase consumption of bottled or filter water. Water distillation using this invention is another example of its use and requirement.

Existing separation processes provide a heat source to heat the material and vaporize the liquid to be separated and if the resultant gas vapor is to be recovered a separated cooling source to remove the required heat of condensation. This method is not energy efficient as the heat required for the process is not recovered resulting in a higher energy consumption rate than necessary and if fossil fuels are the energy source increased atmospheric emissions. This invention (process) offers a closed loop energy recovery system at optimal operating conditions to minimize the generation of energy, minimize the required atmospheric emissions associated with energy generation, minimize the discharge of undesirable gas to the environment and, in most cases, a reduction in operating costs.

### BRIEF SUMMARY OF THE INVENTION

This invention provides a process for the separation and recover of a liquid or liquids from a mixture of material (solid or liquid) with recycled energy by capturing the heat energy associated with the condensing the gas generated during the heating process, and utilizing this energy plus the energy generated or absorbed by the other system components as the heating source thereby recycling the energy and significantly reducing energy generation, environmental emissions, and associated costs. The invention provides control of the system operating pressure (absolute) thereby maximizing compressor heat absorption and transfer capacity providing the highest feasible Coefficient of Performance for the liquid or liquids to be removed.

It is therefore an object of the present invention to provide a heat pump for the removal of a liquid(s) from another liquid(s) or solid(s) through the process of vaporization and condensation with the heat pump performance (capacity) optimized for the liquid to be removed and recovered and provide an optional method of minimizing any unwanted discharge of gas and or liquid to the environment. The heat pump system can be provided for single or multi-stage process, with either single or multi-stage energy capture or recycling.

Another object of the invention is to provide stable operation for the compressor of the heat pump system by providing secondary heat transfer loops, one each for the evaporator and condenser elements of the heat pump system. Said heat transfer loops will have liquid storage capacity for heat sinks and the means to absorb additional energy or discharge from the process excess energy. The heat sink capacity of the system minimizes operating temperature changes and the rate of any change at both the compressor heat rejection and absorption elements. The heat is also available for use each time the system to process the material. For water distillation the secondary loops may be eliminated if desired to minimize system costs.

A further object of the invention is maximizing the ratio of heat absorbed to compressor input power by controlling the system operating pressure for at the vaporization and condensation processes. Such controls allows for the smallest temperature difference between the compressor inlet and outlet temperatures.

The invention further provides a method for direct contact or indirect liquid recovery and storage with the aspect of storage providing chilled liquid storage and heat sink for consistent and stable compressor return gas temperature. This facilitates material separation and recovery reducing or eliminating atmospheric discharge of gases. For water purification this secondary loop cold sink may be eliminated if necessary to minimize system costs.

A further object of the invention is to provide the minimum operating cost through energy recycling by using the heat absorbed by the heat pump as the means for heating the material to be processed. much of its heat to the liquid in the secondary loop 12 condensing the refrigerant to a liquid that passes through the liquid filter 25, control solenoid valve 26, and sight glass 27 to the thermal expansion valve (TX valve) 28. The secondary loop 12 is used to heat the material in the process chamber 14.

The TX valve 28 allows liquid refrigerant under pressure to expand into the evaporative element of the evaporator 29 with the flow rate controlled by the exit temperature sensor. The refrigerant liquid vaporizes to refrigerant vapor picking up heat from the secondary cooling loop 13 from its liquid passing through the evaporator 29 and, as a low temperature gas, is returned to the refrigerant compressor 10. This heat removal provides the secondary loop 13 with a liquid sufficiently cold to cause condensation in the recovery chamber 15 and recovers the energy of condensation and, if so provided, the heat energy resulting from the operation of the liquid ring pump 16. As illustrated, the liquid ring pump 16 seal liquid is the same liquid that is circulated in the secondary loop 13; however, optionally it could be a separate loop cooled separately or the same loop cooled separately.

The secondary liquid loop 12 for heat transfer to the process chamber 14 consists of the condenser 24, flow-splitting valve 36, auxiliary heat exchanger 32, process chamber heating element 33, optional liquid storage volume 34, and a circulating pump 35. All of the rejection heat from the refrigerant loop 11 is transferred to the secondary heating loop 12. The flow-splitting valve 36 is used to divert liquid to the auxiliary heat exchanger 32 for the removal of excess heat energy with said heat exchanger available as air to liquid or liquid-to-liquid type. The optional liquid storage 34 volume provides energy storage for use at the start of the process and provides a heat sink to slow the rate of change and amount of change in operating temperature providing a stable temperature range for the condenser 24 operation.

The process chamber 14 may be a single container that is manually or automatically filled with a mixture of liquids or liquids with a solid or solids. Illustrated in FIG. 1 is the automatic feed of liquids from a batch container 30 though a float valve 31, solenoid valve 37 into chamber 14 with connection to sight glass 40 and vapor mist

A further object of the invention is maximizing the recovery of condensable gases that should not be discharged to atmosphere by accumulating and removing the gas or gases in its liquid state.

Another object of the invention is a simplified method of water distillation operating at a vacuum using energy recycling without secondary heat loops and or mechanical operating pressure control.

### BRIEF DESCRIPTION OF THE SEVERAL VIEWS OF THE DRAWING

FIG. 1 is a schematic circuit diagram of the heat pump system with secondary loops, with block indications for the process chamber, recovery chamber, and liquid ring pump system according to the invention.

FIG. 2 is a schematic circuit diagram for a simplified water distillations system according to the invention.

### DETAILED DESCRIPTION OF THE INVENTION

The invention provides a new process utilizing a heat pump with or without secondary heating or cooling loops for capturing the heat of condensation and recycling this heat, a means to discharge excess heat, a chamber or chambers for the material being processed with a means for feeding/filling it, a chamber for the recovery of the material to be removed from the processed material with a means to remove it, and an absolute pressure control system.

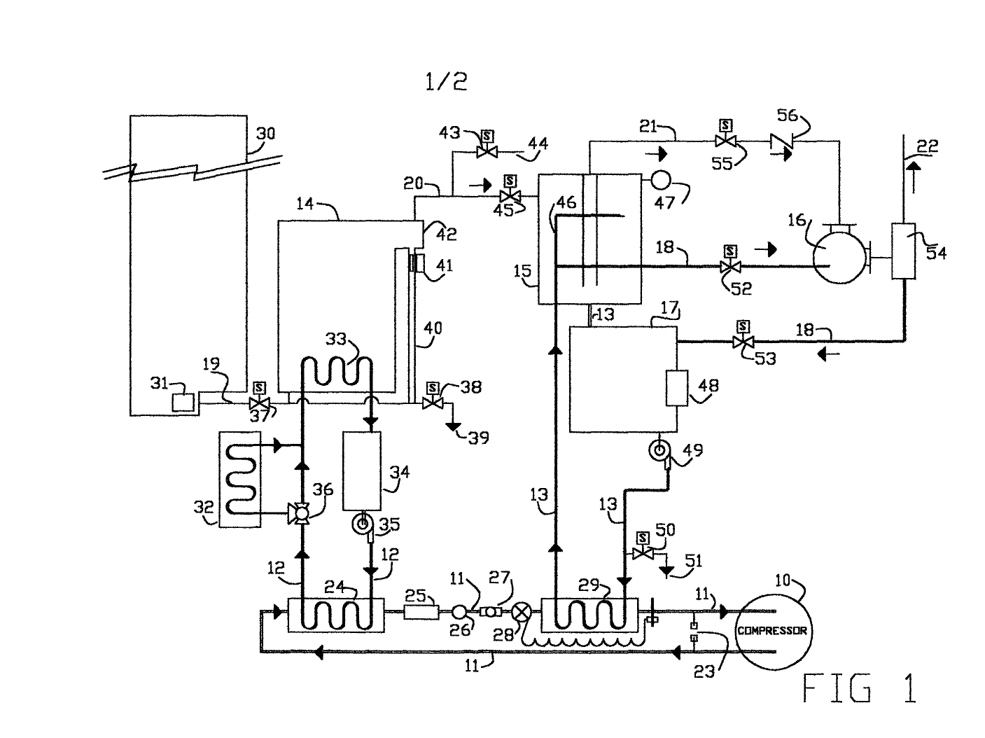

The invention as illustrated in FIG. 1 includes a heat pump system 10 with secondary heat transfer loops 12 & 13; typical material processing chamber 14, typical recovery chamber 15, and liquid ring pump 16.

The primary refrigerant loop 11 incorporates conventional refrigeration cycle or heat pump cycle components including compressor 10, primary condenser 24, and evaporator 29. The compressor pressurizes the refrigerant vapor of a refrigerant such as, for example, R22. At the primary condenser 24, the compressed hot vapor gives up separator 42 of feeding line 19. The heating element 33 of the secondary heating loop heats the contents of chamber 14 causing the liquid or liquids within the chamber to vaporize in accordance with their vapor pressure characteristics. The resultant vapor passes through the vapor mist separator 42 with the mist or liquid separated and returning to the chamber via the slight glass 40. The vapor mist separator is connected to the recovery chamber 15 by line 20. The sight glass 40 contains a float that opens and closes the high level switch 41. This high level switch controls solenoid valve 37 and maintains the chamber full until float valve 31 closes blocking the feed to the system. This float closes when all the liquid in chamber 30 has been transferred to chamber 14.

For blow-down or cleaning purposes of the process chamber 14, manual or automatic valve 38 allows draining the contents to drain 39. Air or other form of pressure can be applied at entrance 44 though valve 43 with valve 45 closed to isolated the process chamber. Such cleaning can be automated or manual.

The vapor generated in the process chamber 14 is drawn into the recovery chamber 15, as the operating pressure of the recovery chamber 15 is less than the vapor pressure generated. Recovery chamber 15 is designed to operate at an absolute pressure to allow for condensation at a low temperature. In order for the liquid in the process chamber 14 to vaporize, it needs to have its temperature increased only above the temperature of condensation achieved by the absolute pressure in the recovery chamber 15. This temperature pressure relationship between the two chambers offers the ability to maximize the heat absorption capacity and resultant Coefficient of Performance of the heat pump system by allowing for a compressor suction temperature close to the compressor discharge temperature at a lower discharge temperature than operations at atmospheric conditions.

The vapor from the process chamber 14 is condensed in the recovery chamber 15 by the direct cooling action of the liquid spray 46. Optionally, not shown, condensation can occur indirectly by using a cooling element or some other form of heat exchanger within the chamber.

The initial vacuum and removal of non-condensable gas from the process chamber 14 and recovery chamber 15 is achieve by the liquid ring pump 16 though a connection line 21 to the recovery chamber 15 including a valve 55 and check valve 56. Valve 56 is available to isolate the liquid ring pump 16 from the chamber if the recovery chamber needs to be pressurized through entrance 44, valve 43 and valve 45. In this illustration the seal liquid for the liquid ring pump 16 is the same liquid that is sprayed and is delivered to the liquid ring pump though line 18 and valve 52. The non-condensable gas and liquid exit the liquid ring pump 16 to the liquid gas separator 54 with the gas exhausted at 22 and the liquid returning through line 18 and valve 53 to a liquid storage tank 17. Valves 53 and 52 are used to isolate the system pressure (absolute) from the liquid ring pump 16 when the pump is not operating. Once the desired absolute pressure is achieved by the liquid ring pump 16, it is stopped and only turns on to remove any additional non-condensable gases that increase the pressure and are sensed by electrical pressure gauge 47.

Condensable gases drawn from the recovery chamber 15 will be condensed in the seal of the liquid ring pump 16 and returned to the liquid storage 17. The energy used to drive the liquid ring pump is seen as a temperature increase in the seal liquid and it as well as any heat of condensation is return for capture and re-use through line 18

The condensation and spray liquid of the recovery chamber 15 accumulates with the seal liquid (when the pump is in operation) in the storage chamber 17 with high and low level control sensor 48. This liquid is pumped continuously during operation through the secondary loop 13 by the pump 49. The level control sensor 48 opens solenoid valve 50 allowing the excess condensate to be sent to drain or to a storage container located at 51. The storage capacity of the storage chamber 17 provides for a source of heat for the heat pump evaporator 29 and operates as a energy sink to minimize temperature changes and the rates at which temperature may change providing for a consistent return gas temperature and smooth operation of the heat pump.

Options to the configuration of FIG. 1 include:

A. A separate liquid ring seal water loop cooled by the heat pump.

B. An air jet using the vapor to be recovered as its motive gas and drawing a vacuum on the recovery chamber to allow for very low operating pressures.

C. The use of indirect cooling in the recovery chamber though an appropriate heat exchanger.

D. Combining the elements of recovery and liquid storage into one vessel.

E. Use of a seal liquid different from the liquid being recovered.

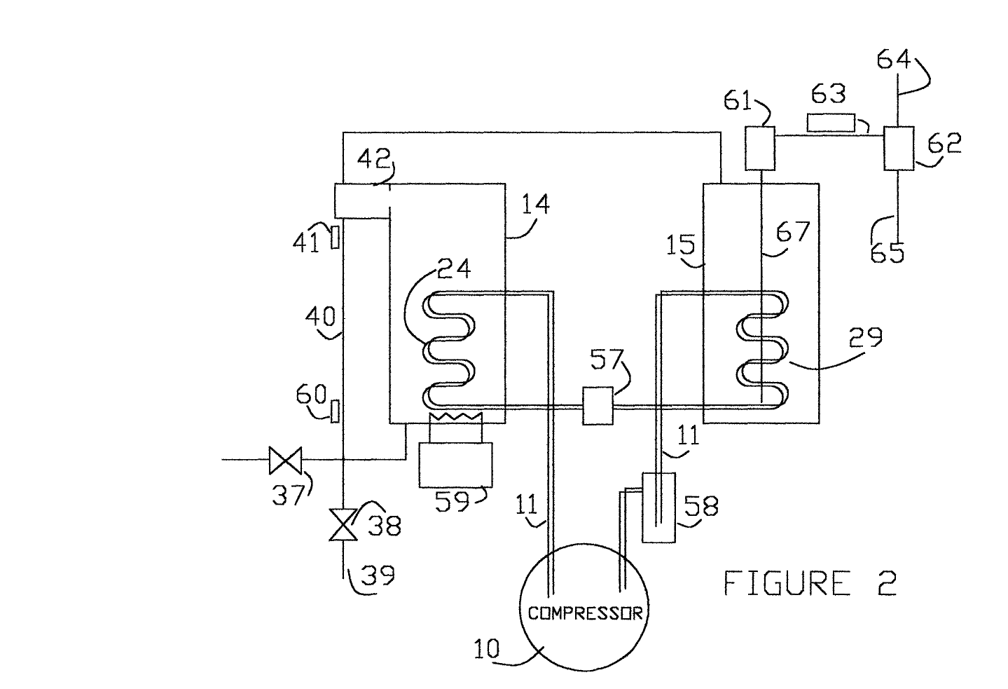

This invention as illustrated in FIG. 2 provides a simplified system for water or other liquid purification without secondary liquid loops and or the liquid ring pump utilized in FIG. 1. Such a process or machine may be single or multistage with each stage consisting of a heat pump circuit (evaporator and condenser), process chambers, recovery chambers, a filling method and a discharge method.

As illustrated the compressor 10 pumps hot refrigerant gas to the heating element (condenser) 24 of the process chamber 14 where the gas condenses to a liquid giving up most of its heat energy to the liquid being processed. The hot liquid refrigerant passes through a pressure-flow control element 57 into the cooling element (evaporator) 29 of the vapor recovery chamber 15. The pressure-flow control element may be as simple as a capillary tube or tubes or as complex as a TX valve. The hot liquid expands vaporizing to a refrigerant gas in the cooling element (evaporator) 29 and returns to the inlet of the compressor 10 via a liquid vapor-separating receiver 58.

The process chamber 14 can be manually filled with the liquid or automatically as shown though solenoid valve 37 with an inlet supply line. The outlet of solenoid valve 37 is to the bottom of the process chamber 14 or to the top of the process chamber 14 via a sight glass 40 for level indication and level control and vapor-mist separator 42. The sight glass 40 includes a float to operate the high-level 41 and low-level 60 sensors. This process chamber 14 also has a direct heater 59 and is connect at its top through the vapor-mist separator to the top of the recovery chamber 15.

The recovery chamber 15 includes a discharge tube 67 that extends to the bottom most level of the chamber with an exit into a directional control valve 61 or other form of check valve. The directional control valve 61 is connected to a second such valve 62 though a temperature sensor 63. An exhaust 64 and delivery tube 65 are connected to the directional control valve 62.

In operation the first filling of the liquid is through solenoid valve 37 into the process chamber 14 until the solenoid valve 37 is closed by the high level sensor 41. During filling and operation the drain solenoid valve 38 is closed blocking drain 39. At indication of being full by high-level sensor 41 heating element 59 is powered heating the liquid in the process chamber to above 212 degree F. sanitizing the liquid and creating steam. The steam will pass through the vapor-mist separator 42 where the mist is separated and dropped into the sight glass 40 for return. The vapor travels into the top of the recovery chamber 15 where being lighter than air displaces the air (non-condensable gases) out of the recover chamber 15 through the discharge tube 67, direction control valves 61 and 62. The steam will exit the system at the exhaust 64 as the directional control valve 62 blocks (prevents) gas from passing into delivery tube 65 where only liquid is allowed. Heater 59 is operated until the temperature sensor 63 reaches a preset temperature indicating that all non-condensable gas has been removed from the both chambers.

The temperature sensor 63 also initiates operation of the heat pump system 10. With the hot refrigerant liquid expanding into a gas at the cooling element 29 (evaporator) the energy in the steam is removed condensing it and creating a vacuum in the recovery chamber 15 and process chamber 14. The recovery chamber 15 is isolated from the atmosphere by the direction control valve 61. The energy heat recovered at the cooling element 29 into the refrigerant is returned to the system along with the heat energy of the compressor 10 power at the heating element 24 (condenser) in the process chamber 14.

As a vacuum was established by the condensation of the steam in the system the heat pump 10 is allowed to operate at temperatures well below those required at atmospheric pressure to vaporize the liquid and at a lower temperature difference between the compressor inlet and discharge temperatures. This allows for the highest possible compressor Coefficient of Performance.

When all the liquid has been vaporized from the process chamber 14 the process is stopped by the low level sensor 60. At this point the next batch or continuation of the system can be automatic or manual depending upon the method and size of the storage container placed to receive the distilled liquid from the delivery tube 65.

What I claim as my invention is:

1. A process utilizing a heat pump to separate and recover a liquid or liquids from other liquids, solids or mixtures of liquids and solids,

2. A heat pump system as in claim 1 were the necessary energy required to vaporize the liquid or liquids is provided by the rejected heat of the heat pump used to absorb the energy removed while condensing the liquid or liquids during liquid recovery including heat pump power,

3. A heat pump system as in claim 1 operating at an absolute pressure that maximizes the Coefficient of Performance of the compressor by reducing both the required vaporization and condensation temperatures for the liquid or liquids being separated.

4. Establishment and maintenance of the absolute pressure of claim 3 using a liquid ring pump for the removal of non-condensable gases whose seal liquid may or may not be the same as that of the liquid or liquids being recovered.
